(19) United States
(12) Patent Application Publication
(10) Pub. No.: US 2024/0227856 A1
(43) Pub. Date: Jul. 11, 2024

(54) VEHICLE DEACTIVATION CONTROL

(71) Applicant: VOLVO TRUCK CORPORATION, Göteborg (SE)

(72) Inventors: Martin WILHELMSSON, Torslanda (SE); Tobias SMIDEBRANT, Göteborg (SE); Linus NORDHOLM, Askim (SE)

(73) Assignee: VOLVO TRUCK CORPORATION, Göteborg (SE)

(21) Appl. No.: 18/396,957

(22) Filed: Dec. 27, 2023

(30) Foreign Application Priority Data
Jan. 10, 2023 (EP) 23150988.6

(51) Int. Cl. B60W 60/00

(52) U.S. Cl. CPC B60W 60/0015; B60W 2300/125; B60W 2556/10

(57) ABSTRACT

A computer system including a processor device is provided. The processor device is configured to receive a deactivation request to deactivate a heavy-duty vehicle. The processor device is further configured to determine a controlled partial deactivation instruction of the vehicle, wherein the controlled partial deactivation instruction is determined by an autonomous model comprising a historical usage pattern of the vehicle. The historical usage pattern comprises information of deactivation events and activation events of the vehicle that has historically occurred at reference time frames. The processor device is further configured to control the vehicle to execute the controlled partial deactivation instruction such that the vehicle is at least partially deactivated either immediately, or after a delay, as determined by the controlled partial deactivation instruction.

### TECHNICAL FIELD

The disclosure relates generally to vehicle control. In particular aspects, the disclosure relates to vehicle deactivation control. The disclosure can be applied in heavy-duty vehicles, such as trucks, buses, and construction equipment. Although the disclosure may be described with respect to a particular vehicle, the disclosure is not restricted to any particular vehicle.

### BACKGROUND

Heavy-duty vehicles are typically operating during long periods of time and over large geographical areas. Although being in operation, the vehicle is not always driving, i.e., being in ongoing motion such that its position is changed. For instance, the vehicle sometimes has to stop at stop-lights, during delivery or pick-up of goods, at traffic stockings, at pedestrian crossings, or at charging stations, to name some common reasons of vehicle stops. During these stops, the vehicle is often entering an idle mode that might cause unnecessary energy consumption. In order to save energy and thus provide a more economic driving procedure, most heavy-duty vehicles of today often comprise control functionality for deactivating the vehicle after a stop has been recorded.

The prior art offers very little versatility in terms of controlling the vehicle deactivation. The required condition in order to execute a vehicle deactivation is often a lapse of a mere fixed timer. Other alternative solutions seen in the art involve performing analyses on states of the vehicle components or (sub)systems to determine whether a deactivation is suitable. These solutions are costly, inaccurate and oftentimes also prone to an energy consumption that even exceeds the corresponding energy consumption of a vehicle that is never deactivated at stops.

The present inventors have realized the above-mentioned deficiencies of the prior art, and are herein presenting improvements in relation to vehicle deactivation control that seek to solve, or at least mitigate, one or more of these deficiencies.

### SUMMARY

According to a first aspect of the disclosure, a computer system comprising a processor device is provided. The processor device is configured to receive a deactivation request to deactivate a heavy-duty vehicle; in response to said receiving, determine a controlled partial deactivation instruction of at least one subsystem of the heavy-duty vehicle, wherein the controlled partial deactivation instruction is determined by an autonomous mode, said autonomous model comprising a historical usage pattern of the heavy-duty vehicle, the historical usage pattern comprising information of deactivation events and activation events of the heavy-duty vehicle having historically occurred at reference time frames; an controlling, by the processor device, the heavy-duty vehicle to execute the controlled partial deactivation instruction such that the heavy-duty vehicle is at least partially deactivated either immediately, or after a delay, as determined by the controlled partial deactivation instruction.

The first aspect of the disclosure may seek to provide a vehicle deactivation control strategy. A technical benefit may include a versatile, energy efficient and robust control procedure that lengthens the lifetime of vehicle components while at the same time provides an economic and eco-friendly driving with minimized emissions and low energy consumption.

According to a second aspect of the disclosure, a computer-implemented method for controlling heavy-duty vehicle deactivation is provided. The method comprises receiving, by a processor device of a computer system, a deactivation request to deactivate a heavy-duty vehicle; in response to said receiving, determining, by the processor device, a controlled partial deactivation instruction of at least one subsystem of the heavy-duty vehicle, wherein the controlled partial deactivation instruction is determined by an autonomous model, said autonomous model comprising a historical usage pattern of the heavy-duty vehicle, the historical usage pattern comprising information of deactivation events and activation events of the heavy-duty vehicle having historically occurred at reference time frames; and controlling, by the processor device, the heavy-duty vehicle to execute the controlled partial deactivation instruction such that the heavy-duty vehicle is at least partially deactivated either immediately, or after a delay, as determined by the controlled partial deactivation instruction.

In some examples, the autonomous model is configured to receive input data comprising usage data of the heavy-duty vehicle with reference to said reference time frames, and the deactivation request, process the input data, and output the controlled partial deactivation instruction as a result of said processing of the input data. A technical benefit may include that the autonomous model will be provided with, process and output information relating to previous vehicle usage, which means that the controlled vehicle activation will be more intelligent.

In some examples, the autonomous model is weighted for some of the reference time frames and/or a particular deactivation request to deactivate the heavy-duty vehicle. A technical benefit may include selective control of certain potentially important reference time frames and/or requests.

In some examples, the autonomous model calculates a cost function, wherein said deactivation and activation events are associated with positive costs, wherein time periods between a deactivation event and a subsequent activation event among said deactivation events and activation events having historically occurred are associated with negative costs. A technical benefit may include being able to perform calculations on various events and putting it into perspective when determining the controlled partial deactivation instruction.

In some examples, the cost function calculates a usage threshold limit by combining the positive and negative costs for said reference time frames. A technical benefit may include providing a combined value that reflects the actual net cost.

In some examples, said executing of the controlled partial deactivation instruction involves determining whether the usage threshold limit is satisfied for a current time frame. A technical benefit may include accurate real-time comparisons such that prompt control of the vehicle deactivation is achieved.

In some examples, the cost function is updated over time by continuously calculating positive and negative costs for the reference time frames. A technical benefit may include robustness for the autonomous model and thus the controlled partial deactivation instruction.

In some examples, the cost function is a forgetting function in response to said continuous calculations of positive and negative costs for the reference time frames. A technical benefit may include dynamically adjusting the autonomous model with new (and improved) data over time. The forgetting function readily adapts to newly encountered data pertaining to a change in vehicle driving or stopping behaviour.

In some examples, the at controlled partial deactivation instruction comprises an instruction to set said at least one subsystem into a lower energy consumption mode; and/or an instruction to deactivate said at least one subsystem. A technical benefit may include dynamic eco-driving functionalities.

In some examples, the reference time frames are recurring time periods. A technical benefit may include being able to discover patterns by the autonomous model such that its performance may be improved.

In some examples, the deactivation request is received from a vehicle subsystem in response to a vehicle subsystem condition being met, or a driver of the heavy-duty vehicle, the driver being a person or an autonomous unit. A technical benefit may include being able to receive the deactivation request from different sources to provide the autonomous model with improved data in a more efficient way.

In some examples, said controlling comprises selectively opening and/or closing of relays of one or more contactors of the heavy-duty vehicle. A technical benefit may include selective control of vehicle contactors such that a lesser energy consumption is achieved.

In some examples, the deactivation and activation events of the heavy-duty vehicle comprises temporal data pertaining to the reference time frames. A technical benefit may include storing time-related information that improves the accuracy in determining the controlled partial deactivation instruction.

According to a third aspect, a heavy-duty vehicle is provided. The heavy-duty vehicle comprises the processor device to perform the method of the second aspect.

In some examples, the heavy-duty vehicle comprises one or more contactors, a contactor being an electromechanical switching device configured to mechanically operate an electric contact of one or more of the at least one subsystem of the heavy-duty vehicle. A technical benefit may include being able to control electromechanical units of the vehicle.

In some examples, the at least one subsystem is an energy-consuming vehicle component. A technical effect may include providing less energy consumption.

According to a fourth aspect, a computer program product is provided. The computer program product comprises program code for performing, when executed by the processor device, the method of the second aspect.

According to a fifth aspect, a control system is provided. The control system comprises one or more control units configured to perform the method of the second aspect.

According to a sixth aspect, a non-transitory computer-readable storage medium is provided. The non-transitory computer-readable storage medium comprises instructions, which when executed by the processor device, cause the processor device to perform the method of the second aspect.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is an exemplary schematic illustration of a heavy-duty vehicle.

FIG. 2 is an exemplary schematic block diagram visualizing data being used by the heavy-duty vehicle for controlling an at least partial deactivation thereof.

FIG. 3 is an exemplary illustration of an autonomous model which may be used to determine an at least partial vehicle deactivation.

FIG. 4 is an exemplary illustration of a road map where the heavy-duty vehicle may operate during reference time periods.

FIGS. 5A-E illustrates exemplary schematic diagrams that may be used in determining an at least partial vehicle deactivation during reference time periods.

FIG. 6 is an exemplary schematic flowchart illustration of a method.

FIG. 7 is an exemplary schematic flowchart illustration of a method.

FIG. 8 is a schematic diagram of a computer system for implementing examples disclosed herein according to one example.

### DETAILED DESCRIPTION

Aspects set forth below represent the necessary information to enable those skilled in the art to practice the disclosure.

As discussed in the Background section, the available prior art solutions are insufficient when it comes to vehicle deactivation control. More specifically, in many situations the deactivation control functionality being in place instead causes an excessive amount of deactivations where and when they are not needed. The present disclosure advantageously analyses when deactivations are needed, to what extent deactivations are needed, and which components deactivations should be targeted at. The present disclosure will therefore not be associated with any risk of deactivating a component that need not be deactivated, or deactivating a component when there is a high risk of the same component needing to be active again in the near future. To this end, the energy efficiency and thus the economic driving approach of the heavy-duty vehicle will be improved while at the same time minimizing component wear and tear.

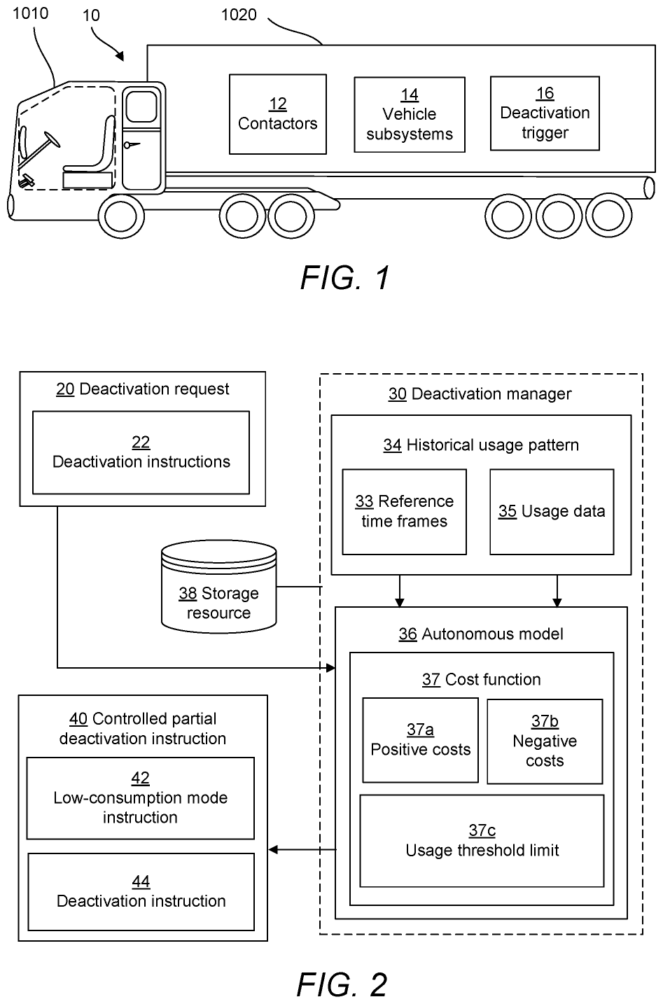

FIG. 1 is an exemplary schematic illustration of a heavy-duty vehicle 10 (hereinafter referred to vehicle 10 for reasons of brevity). This particular vehicle 10 comprises a tractor unit 1010 which is arranged to tow a trailer unit 1020. In other examples, other heavy-duty vehicles may be employed, e.g., trucks, buses, and construction equipment. Although not explicitly visualized in the figure, the skilled person will appreciate that the vehicle 10 comprises all necessary vehicle units and associated functionality such that it may operate as the skilled person would expect of a vehicle 10. Emphasis in the present disclosure is instead directed at the vehicle deactivation control functionality, as will now be discussed.

The vehicle 10 comprises one or more contactors 12, one or more vehicle subsystems 14 and one or more deactivation triggers 16. Although these components 12, 14, 16 are visualized as schematic blocks at the trailer unit 1020, the skilled person will appreciate that these placements are just for illustrative purposes. The units 12, 14, 16 may be arranged and be operable anywhere in the vehicle 10 (for instance at the tractor unit 1010 or at one or more trailer units 1020), or alternatively possibly remotely from the vehicle 10 (i.e., being remotely operable).

The (at least one) contactor 12 may be an electromechanical switching device configured to mechanically operate an electric contact of one or more of the at least one subsystem 14 of the vehicle 10. The electromechanical switching device is preferably a relay. Alternatively, the contactor 12 may be based on other switching technologies, such as magnetically induced switches, mechanical switches, pneumatic switches, light switches, Hall-effect switches, inertial switches, isolator switches, optical switches, piezo switches, pull/push switches, thermal switches, to name a few exemplary switching technologies. The contactor 12 may be disconnected or connected, where each disconnect or connect of the contactor 12 incurs a cost. Contactor 12 connects are shown to be particularly expensive, so it is desired to minimize connects. The present disclosure effectively minimizes the necessary number of disconnects and connects of the contactor 12 by selective control of the vehicle deactivation, for instance via closing/opening of relays.

The (at least one) vehicle subsystem 14 may be an energy-consuming vehicle component, i.e., any component of a vehicle that in some way consumes energy that may potentially be optimized by the smart vehicle deactivation control procedure as presented in this disclosure. The term component shall therefore be interpreted in the broadest of sense, namely as any component that is a part of a vehicle system or subsystem. To this end, the energy-consuming vehicle component may be any one of an engine, a drive train, a braking system, a cooling system, a battery system, an electronic control module (ECU), or any part thereof.

The (at least one) deactivation trigger 16 may be any suitable device capable of providing a deactivation request. The deactivation trigger 16 may be a physical component or a software-controlled component. The deactivation trigger 16 may be manually or automatically controlled. The deactivation trigger 16 may be controlled from within or around the vehicle 10, or from a remote location. The deactivation trigger 16 may be operable by a driver of the vehicle, where the driver is a person or an autonomous unit (in the case of autonomously driven vehicles). Alternatively or additionally, the deactivation trigger 16 may be operable by a vehicle subsystem 14 in response to a vehicle subsystem condition being met. For instance, a battery module may indicate when its charging level has surpassed a certain limit, and in response thereto request to shut down the vehicle 10. In another example, the deactivation trigger 16 may be activated in response to a vehicle standing still for some arbitrary time period.

The deactivation trigger 16 may be a key ignition, a wireless car key, a mobile-device controllable functionality, a physical button or switch or a vehicle subsystem-controllable unit, to name a few exemplary deactivation triggers 16.

If the deactivation trigger 16 utilizes wireless communication, this communication may be based on short-range or long-range communication standards commonly applied in the art. For instance, the short-range or long-range communication standards may include IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any other form of proximity-based device-to-device radio communication signal such as LTE Direct, W-CDMA/HSPA, GSM, UTRAN, LTE or Starlink.

FIG. 2 is an exemplary schematic block diagram visualizing data being used by the heavy-duty vehicle 10 for controlling an at least partial deactivation thereof. The data flow is initiated by the provisioning of a deactivation request 20. The deactivation request 20 may comprise deactivation instructions 22 to deactivate the vehicle. The deactivation request 20 may be initiated by actuation of the deactivation trigger 16, as was discussed with reference to FIG. 1. The deactivation request 20 thus corresponds to a normal deactivation request of the vehicle 10.

The deactivation request 20 may be provided to a deactivation manager 30. The deactivation manager 30 is to be understood as a software module capable of receiving, processing and outputting data associated with the vehicle. The deactivation manager 30 may be provisioned by a vehicle server, or any number of distributed (e.g., cloud) servers. Such a server may be a cloud-based server implemented using any commonly known cloud-computing platform technologies, such as e.g., Amazon Web Services, Google Cloud Platform, Microsoft Azure, DigitalOcean, Oracle Cloud Infrastructure, IBM Bluemix or Alibaba Cloud. Other alternative server configurations may be realized, based on any type of client-server or peer-to-peer (P2P) architecture. Server configurations may thus involve any combination of e.g., web servers, database servers, email servers, web proxy servers, DNS servers, FTP servers, file servers, DHCP servers, to name a few.

The deactivation manager 30 may comprise a storage resource 38. The storage resource 38 may be configured to store data associated with the deactivation manager 30. The storage resource 38 may be maintained by and/or configured as a cloud-based service, being included with or external to the cloud-based server as described above. Connection to the cloud-based storage resource 38 may be established using DBaaS (Database-as-a-service). For instance, the cloud-based storage resource 38 may be deployed as a SQL data model such as MySQL, PostgreSQL or Oracle RDBMS. Alternatively, deployments based on NoSQL data models such as MongoDB, Amazon DynamoDB, Hadoop or Apache Cassandra may be used. DBaaS technologies are typically included as a service in the deactivation manager 30.

In response to receiving the deactivation request 20, the deactivation manager 30 is configured to determine a controlled partial deactivation instruction 40 of at least one subsystem 14 of the vehicle 16. The controlled partial deactivation instruction 40 differs from the deactivation instructions 22 of the deactivation request 20 in that it is not a normal deactivation of the vehicle 10. The purpose of the controlled partial deactivation instruction 40 is to selectively control which, to what extent, and when certain subsystems 14 of the vehicle 10 are to be deactivated. To this end, the controlled partial deactivation instruction 40 may comprise an instruction 42 to set at least one subsystem 14 into a lower energy consumption mode. Alternatively or additionally, the controlled partial deactivation instruction 40 may comprise an instruction 44 to deactivate at least one subsystem 14.

The controlled partial deactivation instruction 40 is then executed, thereby at least partially deactivating a vehicle subsystem 14 either immediately, or after a delay, as determined by a historical usage pattern 34 (which will soon be discussed in detail). The delay may be an arbitrary time period ranging from a few seconds to several hours. The delay is not restricted to any particular duration. The term “at least partially deactivated immediately or after a delay” means that some subsystems 14 are completely deactivated immediately, some other subsystems 14 are deactivated after the delay, and some others are set into a lower energy consumption mode directly or after the delay. The procedure of executing the controlled partial deactivation instruction 40 controls this.

The predefined duration of the delay may depend on a plurality of different factors relating to the historical usage pattern 34 of the vehicle 10. The historical usage pattern 34 may comprise usage data 35 that comprises information of deactivation events and activation events of the vehicle 10 having historically occurred. The historical usage pattern 34 is thus autonomously updated with temporal data pertaining to when these deactivation and activation events have occurred. The temporal data is data that represents a state in time. Accordingly, the temporal data included in the historical usage pattern 34 defines time-related information for all deactivation and activation events that have previously been performed by the vehicle 10. For instance, this may be recorded each time the vehicle 10 receives a deactivation request or each time a deactivation or activation event of any one of the subsystems 14 of the vehicle 10 is recorded. The temporal data may be retrieved by internal vehicle systems, such as a real-time clock module. Alternatively, the temporal data may be retrieved by an external reference time system. The temporal data may for example be measured in seconds, minutes, days, weeks, years, etc.

In view of the above, the deactivation and activation events of the vehicle 10 have historically occurred at reference time frames 33. Reference time frames 33 may be recurring time periods. Recurring time periods can, for instance, be related to time of day (e.g., between 12:00 and 14:00), time of week (e.g., on Tuesdays), time of month (e.g., first half of March), and/or season (during Christmas holidays). To exemplify this, the historical usage pattern 34 may record how many deactivation and activation events that occur between the reference times frames 10:15 and 11:15 on Tuesdays in March on leap years. This is a very specific scenario, but the skilled person will appreciate other more general scenarios. By being aware of this information, the controlled partial deactivation instruction 40 can be dynamically updated and be responsive to the current time in which the deactivation request 20 is received such that an energy efficient partial deactivation of the vehicle 10 can be performed. In other words, the historical usage pattern 34 is used to control what action is to be taken in response to a currently received deactivation request 20.

Further seen in FIG. 2 is an autonomous model 36. The autonomous model 36 is configured to determine the controlled partial deactivation instruction 40 based on the historical usage pattern 34 of the vehicle 10. To this end, the autonomous model 36 comprises information of the historical usage pattern 34, i.e., the previously occurred deactivation and activation events as well as the reference time frames 33. The autonomous model 36 may be configured to compute statistical data associated with the historical usage pattern 34 and related temporal data. The statistical data may be used to provide an intelligent determination of the controlled partial deactivation instruction 40. To this end, the autonomous model 36 comprises self-learning features. The autonomous model 36 may be trained on a dataset comprising previously occurred activation or deactivation events. Whenever a deactivation request 20 is received, the autonomous model 36 may thus perform autonomous classifications based on activation events or deactivation events having previously occurred at the reference time frames 33. The classifications may for instance, relate to the partial deactivations of the vehicle (e.g., delay or no delay, duration of delay, low energy consumption mode or not, and so forth). The autonomous model 36 may implement any known supervised or unsupervised learning algorithm known in the art, such as binary, multi-class, or multi-label classification and/or clustering algorithms. For instance, algorithms such as logistic regression, support vector machines, kernel estimation, decision trees and/or neural networks may be utilized. Furthermore, the autonomous model 36 is capable of learning from each classification of a controlled partial deactivation instruction 40, such that additionally received deactivation requests 20 may be better classified in terms of subsystem 14 wear and tear and/or energy efficiency.

In view of the above, the autonomous model 36 may receive input data comprising usage data 35 of the vehicle 10. The usage data 35 is related to the reference time frames 33. Furthermore, the input data to the autonomous model 36 also includes the deactivation request 20 comprising the deactivation instructions 22. The autonomous model 36 may be further configured to process the input data in order to output the controlled partial deactivation instruction 40. Some of the input data provided to the autonomous model 36 may be weighted for some of the reference time frames 33 and/or some particular deactivation instructions 22. For example, if the deactivation instructions 22 are associated with a requested emergency shutdown, these deactivation instructions 22 will be significantly weighted such that it is guaranteed that no emergency shutdown of the vehicle 10 is delayed. In other examples, some reference time frames 33 are more important than other time frames and can be weighted accordingly. More important reference time frames 33 may include certain hours, weekdays, dates, etc., where it is known that the vehicle 10 will be stopped for longer periods of time or will perform a plurality of deactivation requests 20 in shorter periods of time. Additionally, weights may also be provided for certain reference time frames 33 where it is known that a certain driver that often/seldom requests deactivation of the vehicle 10 will be operating the vehicle 10. Other reasonable weighting schemes may be applied as realized by the skilled person.

Although not shown in FIG. 2, the deactivation manager 30 may in some examples be configured to manage external changes to the reference time frames 33. For instance, if a delivery route schedule of a particular vehicle 10 is changed from midday hours to afternoon hours, or from Tuesdays to Wednesdays, this may be updated accordingly.

In the example shown in FIG. 2, the autonomous model 36 calculates a cost function 37. The deactivation and activation events are associated with positive costs 37a, and time periods between a deactivation event and a subsequent activation event among the deactivation and activation events having previously occurred are associated with negative costs 37b. The other way around would be a possibility as well (i.e., switching which of the events that incur positive and negative costs 37b, 37a). The cost function 37 may calculate a usage threshold limit 37c by combining the positive and negative costs 37a, 37b for various reference time frames 33. Hence, executing the controlled partial deactivation instruction 40 of the subsystem 14 may involve determining whether the usage threshold limit 37c is satisfied for a current time frame. Satisfying the usage threshold limit 37c for a current time frame may be interpreted as current vehicle usage exceeding a limit which is associated with causing a certain type of partial vehicle deactivation.

The cost function 37 may be updated over time by continuously calculating positive and negative costs 37a, 37b for the reference time frames 33. By said continuous calculation, the cost function 37 may be a forgetting function. Forgetting functions are known in the art as a way of describing how accuracy or discriminability declines as the temporal distance from the event to be remembered increases. In this sense, if the cost function 37 detects a change in behaviour of the calculated positive and negative costs 37a, 37b, the computed usage threshold limit 37c may be quickly and dynamically adjusted by over time forgetting previous occurrences of the events that generated the costs 37a, 37b. The cost function 37 acting as a forgetting function readily adapts to newly encountered data pertaining to a change in vehicle driving or stopping behaviour. Forgetting functions have not been applied in the prior art for these purposes and may be particularly effective for intelligent vehicle deactivation control purposes.

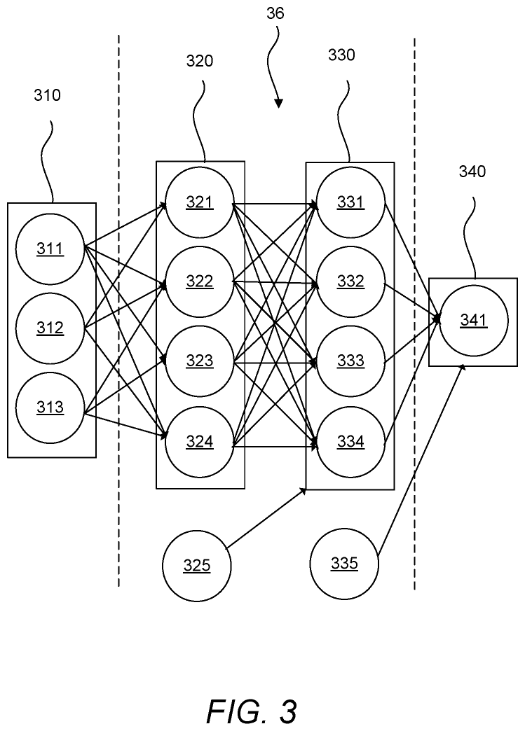

FIG. 3 is an exemplary illustration of an autonomous model 36 which may be used to determine an at least partial vehicle deactivation. The autonomous model 36 is exemplified as a neural network having an input layer 310, two hidden layers 320, 330, and an output layer 340. The input layer 310 comprises three nodes 311, 312, 313, the first hidden layer 320 comprises four nodes 321, 322, 323, 324, the second hidden layer 330 comprises four nodes 331, 332, 333, 334 and the output layer 340 comprises one node 341. Moreover, the neural network comprises two weight nodes 325, 335, each being associated with a respective hidden layer 320, 330. The skilled person appreciates that this is just an exemplary neural network that can be implemented as the autonomous model 36. Other networks may include any suitable number of input nodes, any suitable number of hidden layers and associated hidden nodes, any suitable number of output nodes, and any suitable number of weight nodes. The neural network may implement backpropagation for training purposes such that its performance of classifying vehicle deactivations may be improved. The input nodes 311, 312, 313 may receive input data comprising usage data 35 of the vehicle 10, reference time frames 33 and deactivation requests 20. The output node 341 may output the controlled partial deactivation instruction 40 as a result of the processing of the input data by the hidden layers 320, 330 and associated weight nodes 325, 335.

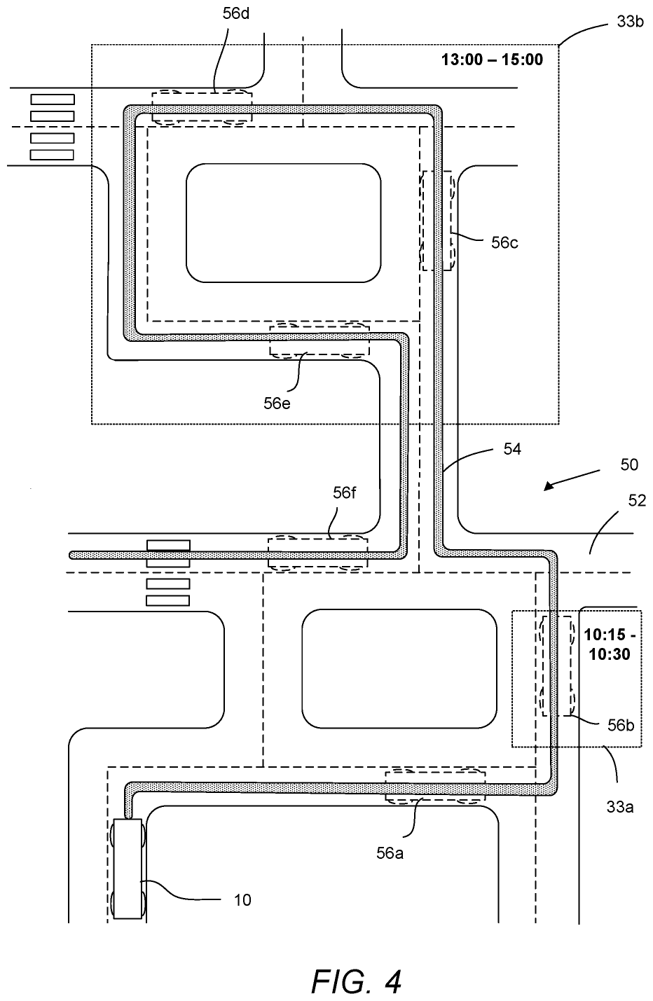

FIG. 4 is an exemplary illustration of a road map 50 where a vehicle 10 may operate during reference time periods. The road map 50 comprises a plurality of interconnected road segments 52, and the vehicle 10 is operating on the road segments 52 while following a general route 54. While travelling on the route 54, the vehicle 10 is assuming a plurality of vehicle positions 56a-f. In the exemplary situation depicted by FIG. 4, it is assumed that the vehicle 10 has previously been travelling generally according to the route 54 sometime in the past. To this end, historical information about previously occurred deactivation and activation events has been retrieved. The historical usage pattern 34 has therefore indicated two distinct reference time frames 33a, 33b where high vehicle deactivation/activation activity is occurring. “Deactivation/activation activity” is to be interpreted as the number of deactivation or activations occurring over a given time period. In this example, the first reference time frame 33a is a shorter time frame that occurs between 10:15 and 10:30, and the second reference time frame 33b is a longer time frame that occurs between 13:00 and 15:00. Since the deactivation/activation activity is high for these particular reference time frames 33a, 33b, deactivation of one or more subsystems 14 of the vehicle 10 is thus delayed between 10:15 and 10:30, and 13:00 and 15:00, respectively, even if requested by the deactivation request 20. In this particular example, this generally occurs when the vehicle 10 is positioned at location 56b, and at positions 56c, 56d, 56e, respectively. For the positions 56a and 56f that are not temporally associated with periods of high deactivation activity, vehicle subsystems 14 may be controlled to be deactivated in response to receiving a deactivation request 20, as it is statistically unlikely that an upcoming activation is to be performed any time in the near future. In either one of the positions 56a-f, the controlled partial deactivation instruction 40 is executed such that the vehicle 10 is at least partially deactivated immediately or after a delay. Clearly, “at least partially” may be no deactivation, a complete deactivation, or anywhere therebetween, as has been discussed above.

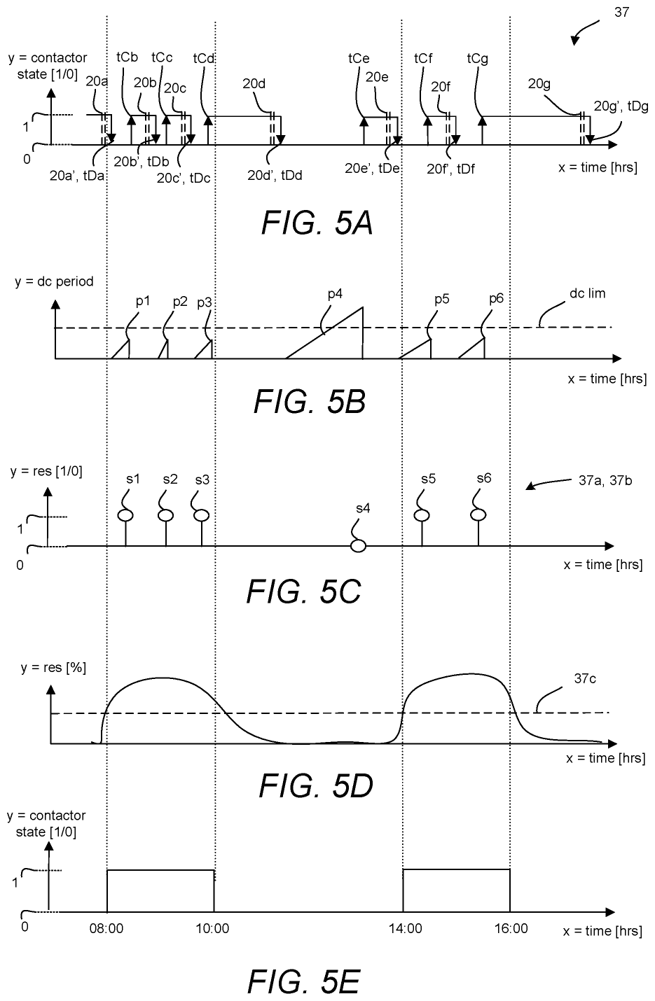

FIGS. 5A-E illustrate exemplary schematic diagrams that may be used in determining an at least partial vehicle deactivation during reference time periods. In the following example, the autonomous model 36 calculates a cost function 37, as was explained with reference to FIG. 2.

FIG. 5A shows a diagram of deactivation requests 20a-g occurring over time [hrs]. After a deactivation request 20a-g has been received, the actual disconnect 20a′-g′will be executed, for instance by a contactor disconnect, after a delay. The time upon which the actual disconnects 20a′-g′ occur are stored as tDa to tDg and the connector state is shifted from “1” to “0”, where “1” on the y-axis corresponds to a contactor being connected, and “0” on the y-axis corresponds to the contactor being disconnected. Further, the times upon which subsequent connects occur are stored as tCa to tCg and the connector state is shifted from “0” to “1”.

The total disconnect periods are calculated by subtracting the connect times tCa to tCg with the disconnect times tDa to tDg, thereby obtaining total disconnect periods p1 to p6, as seen in FIG. 5B. Furthermore, a time limit threshold dc lim is defined. The period p4 that exceeds the time limit threshold dc lim is considered a long disconnect and periods p1, p2, p3, p5, p6 that do not exceed the time limit threshold dc lim are considered short disconnects.

Based on which periods that exceed the time limit threshold dc lim, binary evaluation sample results s1-s6 are determined, as shown in FIG. 5C. As indicated in FIG. 5C, the samples s1, s2, s3, s5, s6 are given “1” as a result and the sample s4 is given “0” as a result. These results are to be considered as incurring positive or negative costs 37a, 37b.

In FIG. 5D, the positive and negative costs 37a, 37b are presented as a continuous cost function y=f(x), where y represents statistical probabilities for a deactivation request 20 to trigger deactivation delay or a lower energy-consumption mode of a subsystem 14 at reference time periods x. Moreover, a suitable usage threshold limit 37c is defined.

FIG. 5E shows, based on the cost function 37, that the reference time periods 8:00 to 10:00 and 14:00 to 16:00 are associated with sufficiently high activity with respect to activation/deactivation events so as to maintain the contactor state at “1” even though deactivation requests 20 are obtained. To this end, the controlled partial deactivation instruction 40 is executed such that deactivation of the vehicle 10 is delayed during the reference time periods 8:00 to 10:00 and 14:00 to 16:00.

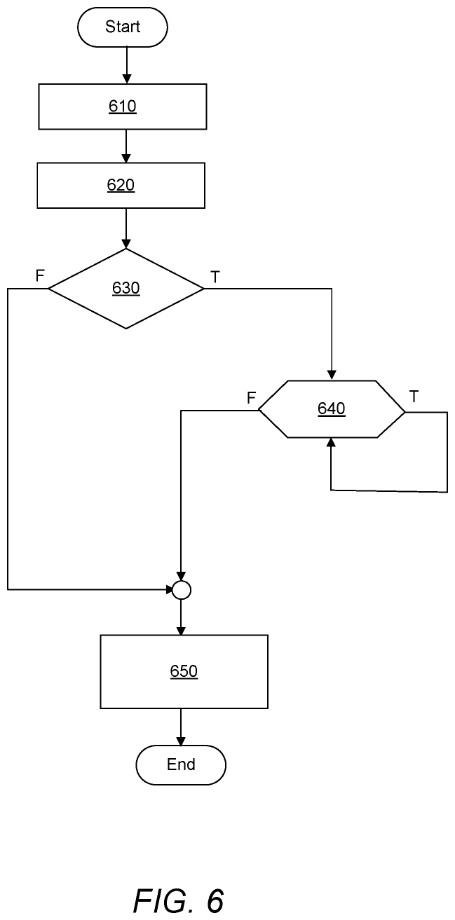

FIG. 6 is an exemplary schematic flowchart illustration of a method. At 610, the method comprises receiving a deactivation request. At 620, the process of determining the controlled partial deactivation instruction is initiated. At 630, a recommended deactivation delay is compared to a threshold limit, and if failing to exceed the threshold limit, the vehicle is deactivated as normal at 650. This corresponds to a normal operation during reference time periods of relatively low activation/deactivation activity. Conversely, if the recommended deactivation delay exceeds the threshold limit, the method proceeds to 640, where a deactivation delay is initiated. The deactivation delay lasts until the vehicle no longer operates within the reference time periods. After this occurs, the vehicle is deactivated at 650. Hence, the method executes the controlled partial deactivation instruction for at least one subsystem by delaying the deactivation at 640.

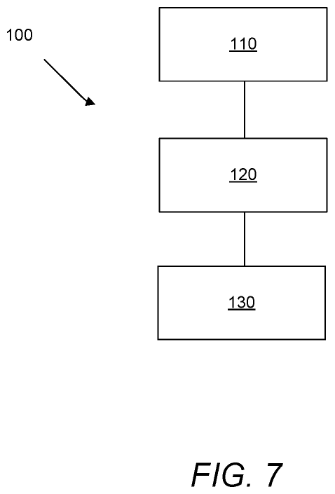

FIG. 7 is a schematic diagram of a flowchart of a computer-implemented method 100 for controlling heavy-duty vehicle activation according to one example. The method 100 comprises receiving 110 a deactivation request to deactivate a heavy-duty vehicle. Further, the method 100 comprises determining 120 a controlled partial deactivation instruction of at least one subsystem of the heavy-duty vehicle, wherein the controlled partial deactivation instruction is determined by an autonomous model, said autonomous model comprising a historical usage pattern of the heavy-duty vehicle, the historical usage pattern comprising information of deactivation events and activation events of the heavy-duty vehicle having historically occurred at reference time frames. The method 100 further comprises controlling 130 the heavy-duty vehicle to execute the controlled partial deactivation instruction such that the heavy-duty vehicle is at least partially deactivated either immediately, or after delay, as determined by the controlled partial deactivation instruction.

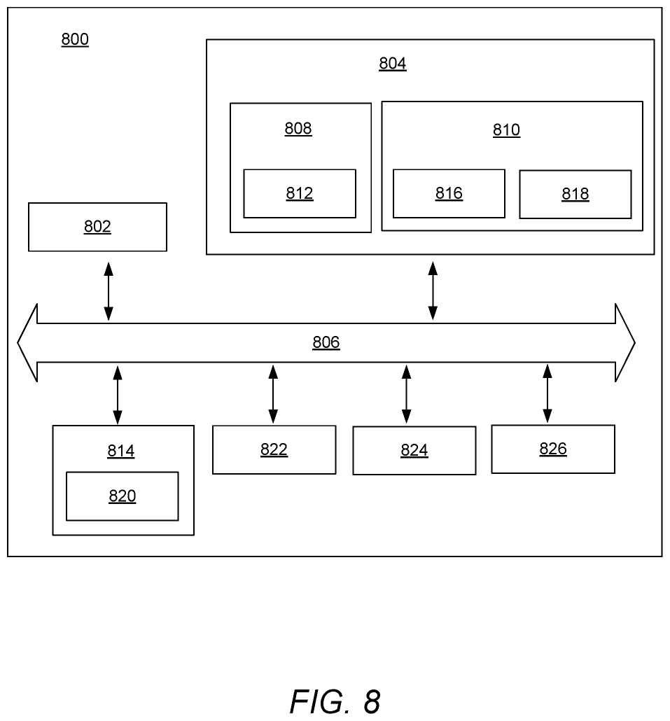

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g.,, networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include a processor device 802 (may also be referred to as a control unit), a memory 804, and a system bus 806. The computer system 800 may include at least one computing device having the processor device 802. The system bus 806 provides an interface for system components including, but not limited to, the memory 804 and the processor device 802. The processor device 802 may include any number of hardware components for conducting data or signal processing or for executing computer code stored in memory 804. The processor device 802 (e.g.,, control unit) may for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processor device 802 (e.g.,, via a circuit or any other wired, wireless, or network connection) and may include computer code for executing one or more processes described herein. The memory 804 may include non-volatile memory 808 (e.g.,, read-only memory (ROM), erasable programmable read-only memory (EPROM), electrically erasable programmable read-only memory (EEPROM), etc.), and volatile memory 810 (e.g.,, random-access memory (RAM)), or any other medium which can be used to carry or store desired program code in the form of machine-executable instructions or data structures and which can be accessed by a computer or other machine with a processor device 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g.,, enhanced integrated drive electronics (EIDE) or serial advanced technology attachment (SATA)), HDD (e.g.,, EIDE or SATA) for storage, flash memory, or the like. The storage device 814 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program product 820 stored on a transitory or non-transitory computer-usable or computer-readable storage medium (e.g.,, single medium or multiple media), such as the storage device 814, which includes complex programming instructions (e.g.,, complex computer-readable program code) to cause the processor device 802 to carry out the steps described herein. Thus, the computer-readable program code can comprise software instructions for implementing the functionality of the examples described herein when executed by the processor device 802. The processor device 802 may serve as a controller or control system for the computer system 800 that is to implement the functionality described herein.

The computer system 800 also may include an input device interface 822 (e.g.,, input device interface and/or output device interface). The input device interface 822 may be configured to receive input and selections to be communicated to the computer system 800 when executing instructions, such as from a keyboard, mouse, touch-sensitive surface, etc. Such input devices may be connected to the processor device 802 through the input device interface 822 coupled to the system bus 806 but can be connected through other interfaces such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g.,, a liquid crystal display (LCD) or a cathode ray tube (CRT)). The computer system 800 may also include a communications interface 826 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer system comprising a processor device configured to:
receive a deactivation request to deactivate a heavy-duty vehicle;
in response to said receiving, determine a controlled partial deactivation instruction of at least one subsystem of the heavy-duty vehicle, wherein the controlled partial deactivation instruction is determined by an autonomous model, said autonomous model comprising a historical usage pattern of the heavy-duty vehicle, the historical usage pattern comprising information of deactivation events and activation events of the heavy-duty vehicle having historically occurred at reference time frames; and
control the heavy-duty vehicle to execute the controlled partial deactivation instruction such that the heavy-duty vehicle is at least partially deactivated either immediately, or after a delay, as determined by the controlled partial deactivation instruction.

2. A computer-implemented method for controlling heavy-duty vehicle deactivation, the method comprising:
receiving, by a processor device of a computer system, a deactivation request to deactivate a heavy-duty vehicle;
in response to said receiving, determining, by the processor device, a controlled partial deactivation instruction of at least one subsystem of the heavy-duty vehicle, wherein the controlled partial deactivation instruction is determined by an autonomous model, said autonomous model comprising a historical usage pattern of the heavy-duty vehicle, the historical usage pattern comprising information of deactivation events and activation events of the heavy-duty vehicle having historically occurred at reference time frames; and
controlling, by the processor device, the heavy-duty vehicle to execute the controlled partial deactivation instruction such that the heavy-duty vehicle is at least partially deactivated either immediately, or after a delay, as determined by the controlled partial deactivation instruction.

3. The method according to claim 2, wherein the autonomous model is configured to:
receive input data comprising usage data of the heavy-duty vehicle with reference to said reference time frames, and the deactivation request,
process the input data, and
output the controlled partial deactivation instruction as a result of said processing of the input data.

4. The method according to claim 2, wherein the autonomous model is weighted for some of the reference time frames and/or a particular deactivation request to deactivate the heavy-duty vehicle.

5. The method according to claim 3, wherein the autonomous model calculates a cost function, wherein said deactivation and activation events are associated with positive costs, wherein time periods between a deactivation event and a subsequent activation event among said deactivation events and activation events having historically occurred are associated with negative costs.

6. The method according to claim 5, wherein the cost function calculates a usage threshold limit by combining the positive and negative costs for said reference time frames.

7. The method according to claim 6, wherein said executing of the controlled partial deactivation instruction involves determining whether the usage threshold limit is satisfied for a current time frame.

8. The method according to claim 5, wherein the cost function is updated over time by continuously calculating positive and negative costs for the reference time frames.

9. The method according to claim 1, wherein the cost function is a forgetting function in response to said continuous calculations of positive and negative costs for the reference time frames.

10. The method according to claim 2, wherein the controlled partial deactivation instruction comprises:
an instruction to set said at least one subsystem into a lower energy consumption mode; and/or
an instruction to deactivate said at least one subsystem.

11. The method according to claim 2, wherein the reference time frames are recurring time periods.

12. The method according to claim 2, wherein the deactivation request is received from:
a vehicle subsystem in response to a vehicle subsystem condition being met, or
a driver of the heavy-duty vehicle, the driver being a person or an autonomous unit.

13. The method according to claim 2, wherein said controlling comprises selectively opening and/or closing of relays of one or more contactors of the heavy-duty vehicle.

14. The method according to claim 2, wherein the deactivation and activation events of the heavy-duty vehicle comprises temporal data pertaining to the reference time frames.

15. A heavy-duty vehicle comprising the processor device to perform the method of claim 2.

16. The heavy-duty vehicle according to claim 15, further comprising one or more contactors, a contactor being an electromechanical switching device configured to mechanically operate an electric contact of one or more of the at least one subsystem of the heavy-duty vehicle.

17. The heavy-duty vehicle according to claim 15, wherein the at least one subsystem is an energy-consuming vehicle component.

18. A computer program product comprising program code for performing, when executed by the processor device, the method of claim 2.

19. A control system comprising one or more control units configured to perform the method of claim 2.

20. A non-transitory computer-readable storage medium comprising instructions, which when executed by the processor device, cause the processor device to perform the method of claim 2.
